(19) United States
(12) Patent Application Publication
(10) Pub. No.: US 2006/0153278 A1
(43) Pub. Date: Jul. 13, 2006

(54) Ear thermometer

(76) Inventors: Kun-Sung Chen, San-Chung (TW); Ying-Chao Lin, San-Chung (TW); Hsing Ouyang, San-Chung (TW); Yao Ouyang, San-Chung (TW); Chun-Nan Chen, San-Chung (TW); Ching-Chin Shiao, San-Chung (TW); Hung-Chang Huang, San-Chung (TW); Chen-Lin Chiu, San-Chung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/032,119

(22) Filed: Jan. 11, 2005

(51) Int. Cl. G01K 1/08; G01J 5/00; G01K 1/00

(52) U.S. Cl. 374/208; 374/121; 374/131

(57) ABSTRACT

An ear thermometer has a main body, and a probe projected from the main body. The ear thermometer has a casing, a sensor module and a plastic tube. The casing has an opening formed in a front side thereof. The sensor module is installed inside the casing. The plastic tube is installed between the casing and the sensor module for positioning the sensor module inside the casing. The probe has an opening formed in a front side thereof for receiving the infrared radiation in a predetermined range. Hence, the sensor module is used to measure true radiation heat from a subject, and prevents the sensor module from measuring an object other than the subject.

### BACKGROUND OF THE INVENTION

1. Field of the Invention

The present invention relates to an ear thermometer, and particularly relates to an ear thermometer having a sensor module for measuring infrared temperature and true radiation heat from a subject, and preventing the sensor module from measuring objects other than the subject.

2. Description of the Related Art

A contact thermometer of the prior art such as a mercury-in-glass thermometer or an electronic thermometer cannot satisfy requirements of users. Hence a new thermometer and a measuring method thereof need to be developed to allow a user to measure and read temperatures easily and accurately, that cannot easily harm the user and is ergonomic. Presently, an infrared non-contact thermometer with the above-mentioned advantage was developed.

Referring to FIG. 1, the infrared ear thermometer of the prior art provides a probe 1 projected therefrom for insertion into an external ear canal of a human. The probe 1 includes a casing 11, a sensor module 12 installed in the casing 11; and a wave guiding tube (copper tube) 13 for conducting heat (IR) from the external ear canal or an eardrum of a human to the sensor module 12. The sensor module 12 is installed on a back of the wave guiding tube 13. The wave guiding tube 13 conducts infrared waves to the sensor module 12 for measuring the temperature of a subject.

However, an inner wall of the wave guiding tube 13 needs a reflection rate that approximates 100% and an absorption rate that approximates 0% for infrared, or else the infrared ear thermometer has an accumulated temperature phenomenon. The accumulates temperature phenomenon means that, because of the wave guiding tube 13 absorbs the infrared to increase temperature of a main body of the infrared ear thermometer, the sensor module 12 detects two radiation powers. Hence, the infrared ear thermometer measures a higher temperature than the true temperature.

Referring to the FIG. 2, another infrared ear thermometer of the prior art was developed for improving the above-mentioned defects. The infrared ear thermometer provides a probe 2. The probe 2 includes a casing 21, and a sensor module 22 installed in the casing 21. The sensor module 22 is a dual-sensor composed of a thermistor and a thermopile (contains a plurality of thermocouples) for measuring the temperature of a subject. The sensor module 22 is installed on a place that can directly sense heat radiation (IR) of the subject for omitting the wave guiding tube between the subject and the sensor module 22. Moreover, the probe 2 further includes a heat insulation portion 23 installed between the casing 21 and the sensor module 22 for preventing the heat to transmit from the casing 21 to the sensor module 22. The heat insulation portion 23 is made of good heat conducting metal material for reducing the error in temperature measurement.

However, the heat insulation portion 23 is made of metal material and projected from a front of the sensor module 22. Hence, the sensor module 22 detects heat from a front side of the heat insulation portion 23. Moreover, the sensor module 22 detects two radiation powers and measures a higher temperature than the true temperature.

Obviously, two sensor modules of the two infrared ear thermometers of the prior art detect the temperature from both of the subject and other objects (such as wave guiding tube 13 and heat insulation portion 23) of the infrared ear thermometers. Hence the infrared ear thermometer will measure a higher temperature than the true temperature.

### SUMMARY OF THE INVENTION

The present invention provides an ear thermometer. The ear thermometer has a sensor module for measuring true radiation heat from a subject, and prevents the sensor module from measuring objects other than the subject.

One aspect of the invention is an ear thermometer. The ear thermometer has a main body, and a probe projected from the main body. The ear thermometer includes a casing, a sensor module and a plastic tube. The casing is open in a front side thereof. The sensor module is installed inside the casing. The plastic tube is installed between the casing and the sensor module for positioning the sensor module inside the casing. The probe has an opening formed in a front side thereof for receiving the infrared radiation in a predetermined range.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objectives and advantages of the present invention will be more readily understood from the following detailed description when read in conjunction with the appended drawing, in which:

FIG. 1 is a cross-sectional view of a probe of an infrared ear thermometer according to the prior art;

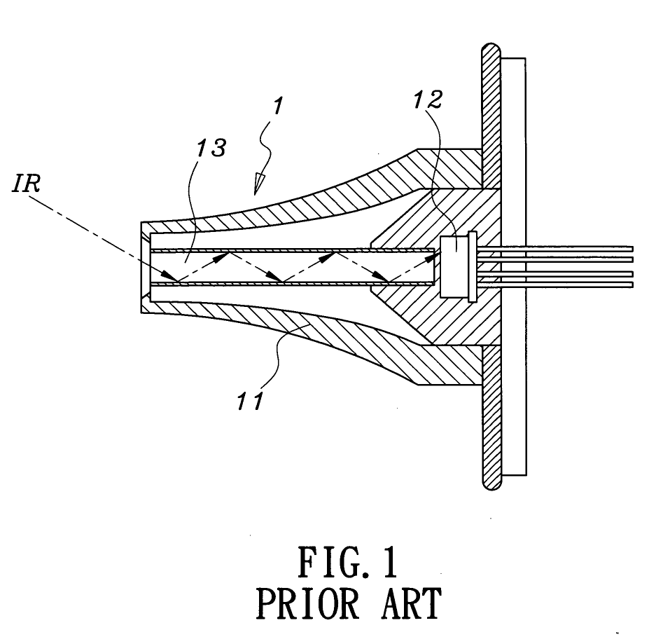

FIG. 2 is another cross-sectional view of a probe of an infrared ear thermometer according to the prior art;

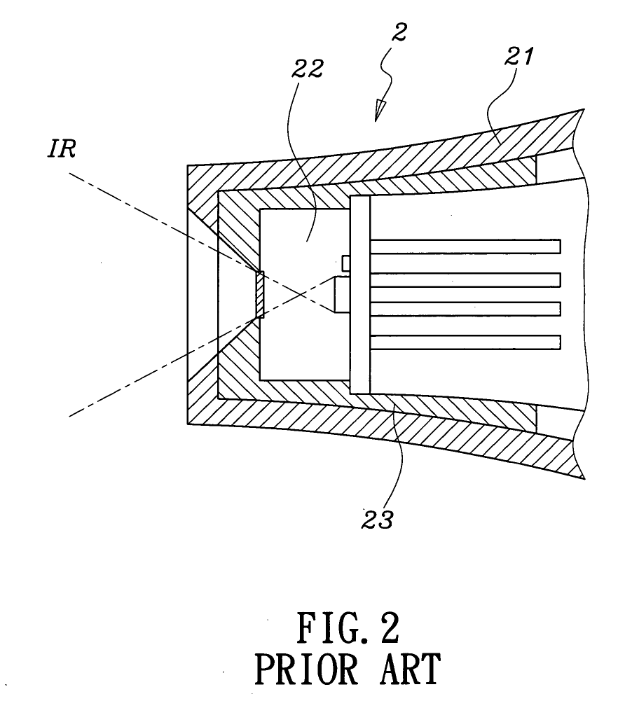

FIG. 3 is a cross-sectional view of a probe of an ear thermometer according to the present invention; and

FIG. 4 is a magnified view of portion A of FIG. 3 according to the present invention.

### DETAILED DESCRIPTION OF PREFERRED EMBODIMENTS

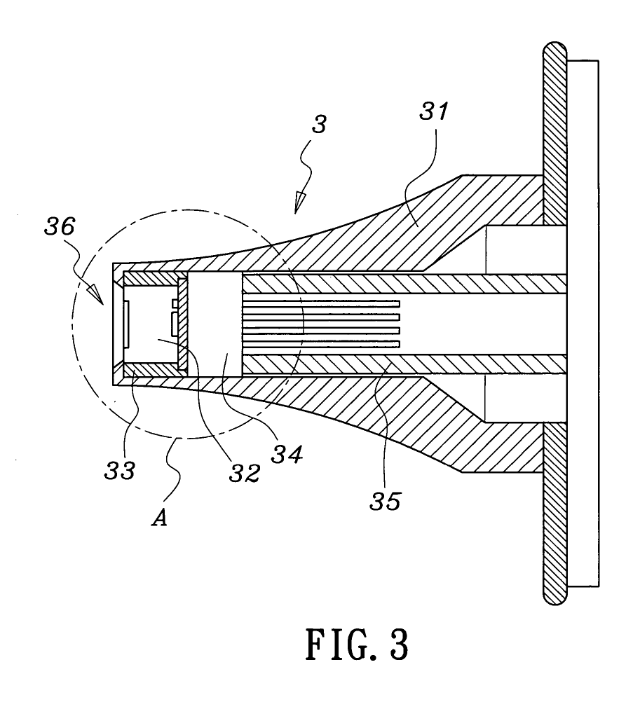

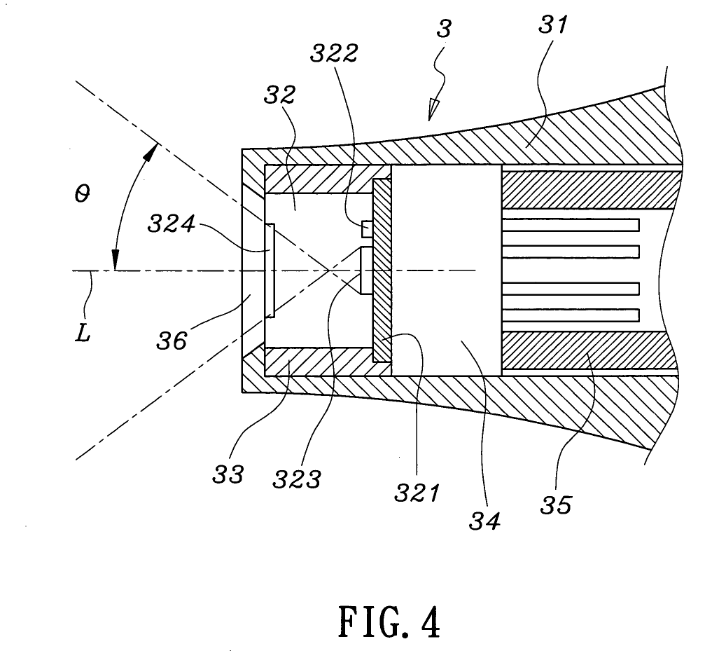

Referring to FIGS. 3 and 4, the present invention provides an ear thermometer. The ear thermometer includes a probe 3 projected from a main body (not shown) thereof for insertion into an external ear canal of a human. The probe 3 is composed of a casing 31, a sensor module 32 and a plastic tube 33. The casing 31 is a plastic hollow casing projected from the main body (not shown) of the ear thermometer. The casing 31 has an opening formed in a front side thereof.

The sensor module 32 is, installed in the casing 31. The sensor module 32 has a base plate 321, and a thermistor 322 and a thermopile 323 are installed on the base plate 321. The thermopile 323 is composed of a plurality of thermocouples connected, together. The thermistor 322 and the thermopile 323 are assembled to form a dual-sensor. The sensor module 32 has an infrared filter lens 324 installed on a front side thereof. The thermistor 322 is used to measure the temperature of a main body of the sensor module 32. The thermopile 323 is used to measure the temperature difference between the subject and the sensor module 32. Hence, the true temperature of the subject is measured. The sensor module 32 is installed on a place that can directly sense heat radiation of the subject and omit the wave guiding tube between the subject and the sensor module 32.

The plastic tube 33 is made of plastic material such as rubber or silica gel. The plastic tube 33 covers an external portion of the sensor module 32, and is installed between the sensor module 32 and the casing 31. The plastic tube 33 with an elastic function is used to position the sensor module 32 in the casing 31. Moreover the plastic tube 33 is waterproof Furthermore, the probe 3 has a first support 34 and a second support 35 installed in the casing 31. The first support 34 and the second support 35 are fixed in the casing 31. The first support 34 has a front side that abuts against and presses upon a rear side of the plastic tube 33 for positioning the waterproof plastic tube 33. The probe 3 has an opening 36 formed in a front side thereof for receiving the infrared radiation in a predetermined range that does not include any non-subject.

Referring to FIG. 4, the sensor module 32 has a vertical line as a central line L. The infrared filter lens 324 has a surrounding mating with the thermopile 323 to form an angle θ (about 45 degrees) relative to the central line L. There is no another object except subject in the range of the angle θ. Hence the sensor 32 measures the whole infrared radiation in the range of the angle 2θ.

The present invention provides an ear thermometer without heat insulation portion, and only needs a waterproof plastic tube 33 with a positioning function. Moreover, the probe 3 has an opening 36 formed in a front side thereof for receiving the infrared radiation in a predetermined range that does not include any non-subject. Hence the sensor module is used to measure true radiation heat from a subject, and prevents the sensor module from measuring an object other than the subject.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

1. An ear thermometer having a main body and a probe projected from the main body, the ear thermometer comprising:
a casing having an opening formed in a distal end thereof;
a sensor module installed inside the casing adjacent the distal end and being devoid of a waveguide at an infrared radiation receiving aperture thereof; and
a plastic tube installed between the casing and the sensor module and circumferentially surrounding the sensor module for positioning the sensor module inside the casing; whereby, the probe has an opening formed in a front side thereof to expose the infrared receiving aperture for the sensor module through which infrared radiation in a predetermined range is received.

2. The ear thermometer as claimed in claim 1, wherein the sensor module has a base plate, a thermistor and a thermopile being installed on the base plate to form a dual-sensor, and an infrared filter lens is installed on a front side thereof, the thermopile being composed of a plurality of thermocouples connected together.

3. The ear thermometer as claimed in claim 1, wherein the plastic tube is made of rubber material.

4. The ear thermometer as claimed in claim 1, wherein the plastic tube is made of silica gel material.

5. The ear thermometer as claimed in claim 1, wherein the probe has a support installed in the casing for abutting against and pressing upon a rear side of the plastic tube.
